(19) United States
(12) Patent Application Publication
(10) Pub. No.: US 2009/0215979 A1
(43) Pub. Date: Aug. 27, 2009

(54) Process for the preparation of alkoxyamine functionalized polyethylene glycols

(75) Inventor: Florencio Zaragoza Dorwald, Smorum (DK)

Correspondence Address: NOVO NORDISK, INC.;INTELLECTUAL PROPERTY DEPARTMENT, 100 COLLEGE ROAD WEST, PRINCETON, NJ, 08540, US

(73) Assignee: Novo Nordisk A/S, Bagsvaerd (DK)

(21) Appl. No.: 11/918,795

(22) PCT Filed: Feb. 7, 2006
(86) PCT No.: PCT/EP2006/050720

§ 371 Date: Jan. 12, 2009

(30) Foreign Application Priority Data
Feb. 8, 2005 (EP) 05388010.0

(51) Int. Cl. C08G 73/10

(52) U.S. Cl. 528/322

(57) ABSTRACT

A method for the preparation of alkoxyamine-functionalised PEG molecules is provided.

### FIELD OF THE INVENTION

The present invention relates to methods of preparing alkoxyamine-functionalised polyethylene glycol.

### BACKGROUND OF THE INVENTION

A well-known method for conjugation of peptides, e.g., to improve their pharmacological properties, comprises the step reacting an alkoxyamine functionalised polyethylene glycol (PEG) with a peptide derived aldehyde or ketone to provide a peptide covalently linked to PEG via an oxime bond. For a review, see Roberts, M. J. et. al, Adv. Drug Deliv. Rev. 2002, 54, 459-476, Kinstler, O. et al., Adv. Drug Deliv. Rev. 2002, 54, 477-485.

Alkoxyamine functionalised PEG are normally prepared by treatment of a Boc-(aminoxy)acetyl derivative with a PEG-derived amine, followed by acid mediated removal of the Boc group, as described by Gaertner and Offord, Bioconjugate Chem., 7, 38-44, 1996. Most commercially available PEG-derivatives are acylating agents, i.e., carboxylic acid derivatives, and the preparation of PEG-derived alkoxylamine derivatives may require the use of a diamine-spacer, and thus several synthetic operations and purifications of intermediates, as outlined in the Scheme below. Such multistep procedure are tedious and time-consuming, and lower the yield of final product. The monoacylation of a diamine may lower the yield of final product significantly, because such reactions usually yield as byproduct a diacylated diamine (Jacobson et al., J. Org. Chem. 1987, 52, 2592).

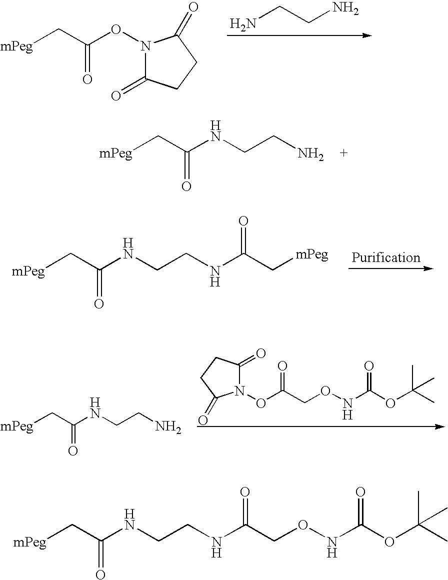

There is thus a need for the provision of simple, fast and efficient methods for the preparation of alkoxyamine functionalised PEG, ideally in one or two synthetic steps.

### SUMMARY OF THE INVENTION

The present invention has surprisingly found that alkoxyamine functionalised PEG may be prepared in a reaction between an excess of an amine containing a protected alkoxyamine functionality and a readily available, PEG-derived acylating agent, followed by removal of un-reacted amine by means of an acidic ion exchange resin.

The present invention thus provides a method for preparing a compound according to formula I,

R¹—R²—O—NH₂ (I)

wherein R¹ is a monovalent acyl radical of formula

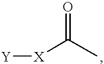

wherein X represents a bond, arylene, (CH₂)₁₋₁₀, NH, O, S, or combinations thereof, and Y represents a branched or unbranched PEG-derived radical having a mean molecular weight between 100 Da and 80 kDa; and

R² is a diradical of formula

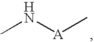

wherein A represents arylene, alkylene, cycloalkylene, heteroarylene, partially or completely saturated heteroarylene, or combinations thereof, each of which optionally substituted with a lower alkyl, the method comprising the steps of

(i) treating a compound of formula II

R¹-LG (II),

wherein LG represents a leaving group for nucleophilic displacement, with an excess of a compound of formula III

H—R²—O—NH-Pg (III)

wherein Pg represent a protective group in a suitable solvent or solvent mixture;

(ii) isolating any compound of formula (IV)

R¹—R²—O—NHPg (IV); and

(iii) removing the protective group to obtain a compound of formula I.

In one embodiment, the present invention relates to a method for the preparation of compounds accordingly to formula I,

R¹—R²—O—NH₂ (I)

wherein R¹ represents

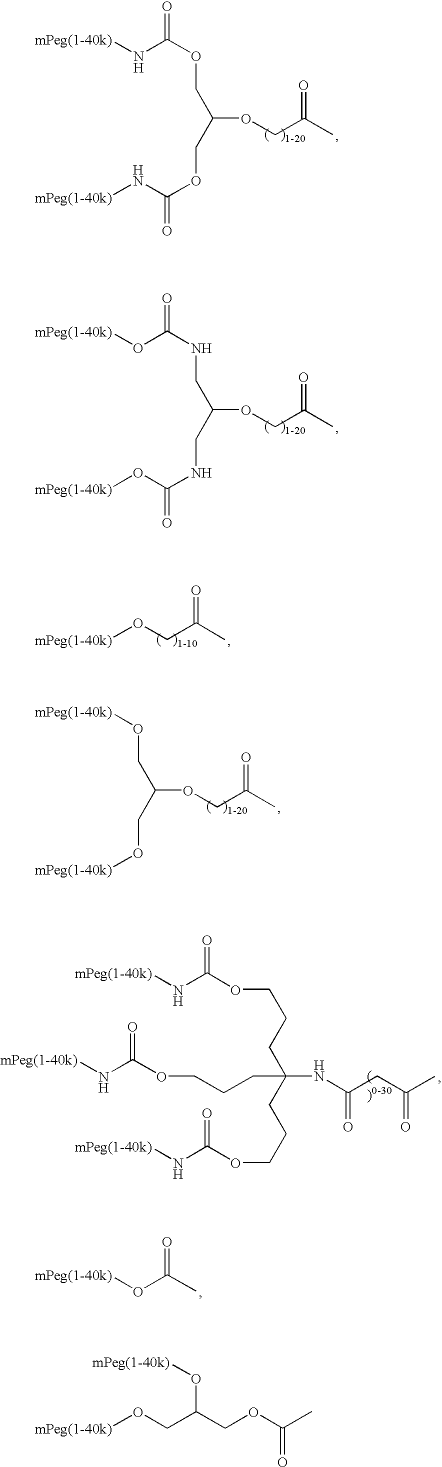

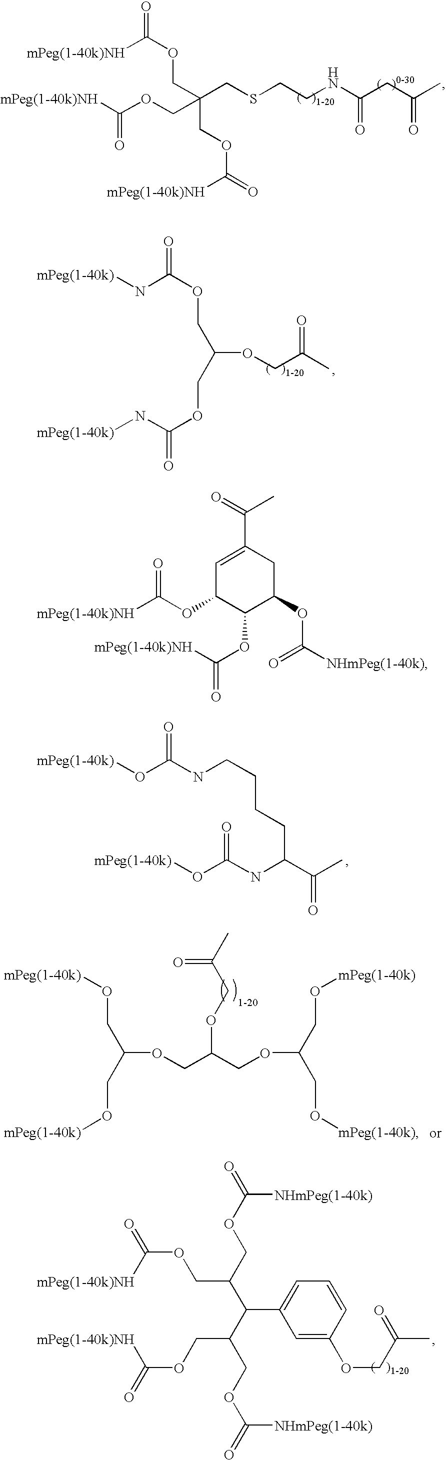

R² represents

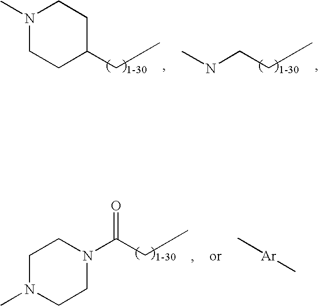

wherein Ar represents arylene or heteroarylene, both of which may optionally be substituted with one or more substituents selected from carboxy, hydroxyl, nitro, or cyano, the method comprising the steps of
(a) treating a compound of formula II

R¹-LG (II),

wherein LG represent a leaving group for nucleophilic displacement, with an excess of a compound of the formula (III)

H—R²—O—NH-Pg (III),

wherein Pg represents a protective group, in a suitable solvent or solvent mixture, followed by
(b) precipitation of the product obtained in (a) by addition of a large amount of a suitable solvent, in which the compound of formula (IV) is essentially insoluble, and the reaction solvent and the compound of general formula (III) are soluble, wherein the compound of formula (IV) is the compound of formula I with a protection group, i.e.

R¹—R²—O—NHPg (IV)

followed by,
(c) isolation of the compound of formula (IV) by filtration, followed by
(d) addition of a suitable solvent in which the compound of formula (IV) is soluble to the product isolated in step (c), followed by
(e) optional repetition of the precipitation, filtration and solubilisation steps of (b) and (c), followed by
(f) addition of a suspension of an acidic ion exchange resin in a suitable solvent, stirring the resulting mixture, followed by filtration and rinsing of the ion exchange resin, and collection and optional concentration of the combined filtrates, followed by
(g) optional addition of a suitable solvent to precipitate the compound of formula (IV), followed by filtration and solubilisation as described in steps (b) and (c), followed by
(h) removal of the protective group with a suitable reagent to obtain a compound of formula I, and optional removal of the solvent and un-reacted reagent.

### DEFINITIONS

The term “alkane” is intended to indicate a saturated, linear, branched and/or cyclic hydrocarbon. Unless specified with a number of carbon atoms, the term is intended to indicate hydrocarbons with from 1 to 30 (both 1 and 30 included) carbon atoms, such as 1 to 20 (both included), such as from 1 to 10 (both 1 and 10 included), e.g., from 1 to 5 (both 1 and 5 included). The terms alkyl and alkylene refer to the corresponding radical and bi-radical, respectively.

The term “aryl” as used herein is intended to indicate carbocyclic aromatic ring systems comprising one or more rings, such as phenyl, biphenylyl, naphthyl, anthracenyl, phenanthrenyl, fluorenyl, indenyl, pentalenyl and azulenyl. Aryl is also intended to include the partially hydrogenated derivatives of the multi-ring carbocyclic systems enumerated above, wherein at least one ring is aromatic. Examples of such partially hydrogenated derivatives include 1,2,3,4-tetrahydronaphthyl and 1,4-dihydronaphthyl. The term “arylene” is intended to indicate the corresponding bi-radical, and examples include 1,2-phenylene, 1,3-phenylene, 1,4-phenylene, 1,2-naphthylene, 1,4-naphthylene, 4,4′-biphenylene, 4,4″-terphenylene and 4,4′″-quaterphenylene.

The term “heteroaryl” as used herein is intended to indicate radicals of heterocyclic aromatic ring systems containing one or more heteroatoms selected from nitrogen, oxygen and sulphur, such as furyl, thienyl, pyrrolyl, oxazolyl, thiazolyl, imidazolyl, isoxazolyl, isothiazolyl, 1,2,3-triazolyl, 1,2,4-triazolyl, pyranyl, pyridyl, pyridazinyl, pyrimidinyl, pyrazinyl, 1,2,3-triazinyl, 1,2,4-triazinyl, 1,3,5-triazinyl, 1,2,3-oxadiazolyl, 1,2,4-oxadiazolyl, 1,2,5-oxadiazolyl, 1,3,4-oxadiazolyl, 1,2,3-thiadiazolyl, 1,2,4-thiadiazolyl, 1,2,5-thiadiazolyl, 1,3,4-thiadiazolyl, tetrazolyl, thiadiazinyl, indolyl, isoindolyl, benzofuryl, benzothienyl, indazolyl, benzimidazolyl, benzthiazolyl, benzisothiazolyl, benzoxazolyl, benzisoxazolyl, purinyl, quinazolinyl, quinolizinyl, quinolinyl, isoquinolinyl, quinoxalinyl, naphthyridinyl, pteridinyl, carbazolyl, azepinyl, diazepinyl, acridinyl and the like. The term is also intended to include partially hydrogenated derivatives of the multi-ring heterocyclic systems enumerated above, provided at least one ring comprising a hetero atom is aromatic. Examples of such partially hydrogenated derivatives include 2,3-dihydrobenzofuranyl, pyrrolinyl, pyrazolinyl, indolinyl, oxazolidinyl, oxazolinyl and oxazepinyl. The term “heteroarylene” is intended to indicate the corresponding bi-radical, and examples include 1,2,4-pyrazol-2,5-diyl, imidazol-1,2-diyl, thiazol-2,4-diyl, (4-phenylimidazole)-4,1′-diyl and (3,5-diphenyl-1,2,4-oxadiazole)-4,4″-diyl.

The term “PEG” is intended to indicate polyethylene glycol of a molecular weight between approximately 100 and approximately 1,000,000 Da, including analogues thereof, wherein for instance the terminal OH-group has been replaced by an alkoxy group, such as e.g. a methoxy group, an ethoxy group or a propoxy group. In particular, the PEG wherein the terminal —OH group has been replaced by methoxy is referred to as mPEG.

The term “mPEG” (or more properly “mPEGyl”) means a polydisperse or monodisperse radical of the structure

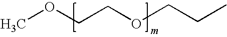

wherein m is an integer larger than 1. Thus, an mPEG wherein m is 90 has a molecular weight of 3991 Da, i.e. approx 4 kDa. Likewise, an mPEG with an average molecular weight of 20 kDa has an average m of 454. Due to the process for producing mPEG these molecules often have a distribution of molecular weights. This distribution is described by the polydispersity index.

The term “polydispersity index” as used herein means the ratio between the weight average molecular weight and the number average molecular weight, as known in the art of polymer chemistry (see e.g. “Polymer Synthesis and Characterization”, J. A. Nairn, University of Utah, 2003). The polydispersity index is a number which is greater than or equal to one, and it may be estimated from Gel Permeation Chromatographic data. When the polydispersity index is 1, the product is monodisperse and is thus made up of compounds with a single molecular weight. When the polydispersity index is greater than 1 it is a measure of the polydispersity of that polymer, i.e. how broad the distribution of polymers with different molecular weights is.

The use of for example “mPEG20000” in formulas, compound names or in molecular structures indicates an mPEG residue wherein mPEG is polydisperse and has a molecular weight of around 20 kDa.

The polydispersity index typically increases with the molecular weight of the PEG or mPEG. When reference is made to 5 kDa PEG and in particular 5 kDa mPEG it is intended to indicate a compound (or in fact a mixture of compounds) with a polydisperisty index below 1.06, such as below 1.05, such as below 1.04, such as below 1.03, such as between 1.02 and 1.03. When reference is made to 10 kDa PEG and in particular 10 kDa mPEG it is intended to indicate a compound (or in fact a mixture of compounds) with a polydisperisty index below 1.06, such as below 1.05, such as below 1.04, such as below 1.03, such as between 1.02 and 1.03. When reference is made to 15 kDa PEG and in particular 15 kDa mPEG it is intended to indicate a compound (or in fact a mixture of compounds) with a polydisperisty index below 1.06, such as below 1.05, such as below 1.04, such as below 1.03, such as between 1.02 and 1.03. When reference is made to 20 kDa PEG and in particular 20 kDa mPEG it is intended to indicate a compound (or in fact a mixture of compounds) with a polydisperisty index below 1.06, such as below 1.05, such as below 1.04, such as below 1.03, such as between 1.02 and 1.03. When reference is made to 30 kDa PEG and in particular 30 kDa mPEG it is intended to indicate a compound (or in fact a mixture of compounds) with a polydisperisty index below 1.06, such as below 1.05, such as below 1.04, such as below 1.03, such as between 1.02 and 1.03. When reference is made to 40 kDa PEG and in particular 40 kDa mPEG it is intended to indicate a compound (or in fact a mixture of compounds) with a polydisperisty index below 1.06, such as below 1.05, such as below 1.04, such as below 1.03, such as between 1.02 and 1.03. When reference is made to 60 kDa PEG and in particular 60 kDa mPEG it is intended to indicate a compound (or in fact a mixture of compounds) with a polydisperisty index below 1.06, such as below 1.05, such as below 1.04, such as below 1.03, such as between 1.02 and 1.03.

### DETAILED DESCRIPTION OF THE INVENTION

The overall reaction of the methods of the present invention may be described by the following reaction sequence

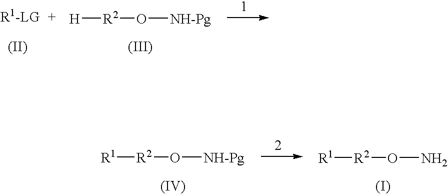

In one embodiment, the method of the invention can be described by the following reaction sequence:

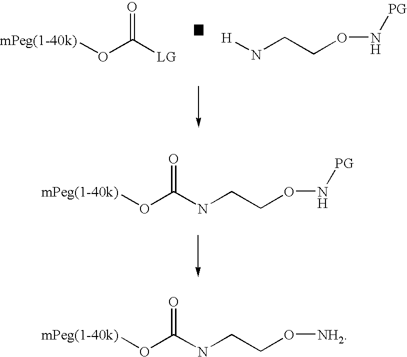

LG in the compound of formula (II) represents a leaving group for nucleophilic displacement. Examples of LG include halide, azide, N-succinimidyloxy, 1-imidazolyl, 1-triazolyl, 1-tetrazolyl, N-benzotriazolyloxy, N-phthalimidyloxy, phenyloxy, and 4-nitrophenyloxy.

In a particular embodiment, the method of the invention can be described by the following reaction sequence:

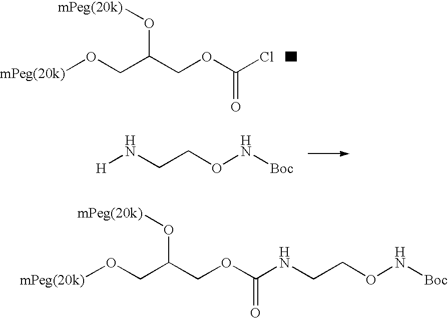

The compound of formula (III) is added in excess over the compound of formula II in order to drive the acylation reaction (reaction 1) to completion in a reasonable time. Typically, the excess is 1.5-300 fold, such as 2-10 fold.

The compounds of formula (III) and (IV) comprise a protecting group, Pg, to protect the amine functionality during the reaction. Typical examples of protecting groups know in the art includes Boc, Fmoc, Cbz, Bpoc, Mpc, Ddz, Adpoc, Azoc, Alloc, and Troc. It is preferred to use protective groups Pg, which enable final deprotection under mild conditions, which do not harm the final product of the reaction, and furthermore only yield volatile by-products during the deprotection, which are easy to remove, e.g. under reduced pressure. Examples of such Pg include Boc, Cbz and Alloc.

The acylation reaction may be conducted in a suitable solvent, such as dichloromethane, chloroform, tetrachlorocarbon, carbon disulfide, nitrobenzene, acetonitrile, ethyl acetate, propionitrile, chlorobenzene, toluene, or in a solvent mixture, optionally in the presence of a catalyst or a base, such as DIPEA, DMAP, triethylamine, or pyridine to accelerate the reaction. Particular mentioning is made of dichloromethane.

Before removal of the protective group Pg, it is of critical importance to remove the excess amine (of formula (III)), because this compound yields, upon deprotection, an alkoxylamine which will compete with the compound of formula (I) in the condensation reaction with the peptide-derived aldehyde or ketone, leading to low yields of the desired condensation product. The present invention provides a practical method for the removal of amine (III). This method yields highly pure products of general formula (I), and represents a significant improvement compared with the lengthy and tedious procedures reported in the literature. The purity of the products of general formula (I) is essential if high yields of condensation products with peptide-derived aldehydes or ketones are to be obtained.

The removal of the excess of compound (III) from the compound of formula (IV) can be achieved by treatment of a solution of the crude product (IV) in a suitable solvent, such as dichloromethane, chloroform or water, with a sufficient amount of an acidic ion exchange resin, such as Amberlyst 15, Amberlyst 36, Amberjet 1200(H), Amberlite IR-120, Amberlite IRC-50, Amberlite IRP, Dowex 50WX, Dowex HCRW2, Dowex 650C, Dowex DR-2030, or Dowex HCR-S for between 1 min and several hours, e.g. 1, 2, 3, 4, 5, or 10 hours. Particular mentioning is made of dichloromethane as solvent. Filtration, rinsing of the ion exchange resin and concentration or lyophylization of the combined filtrates yields the product (IV), devoid of reagent (III) or other, basic by-products or catalysts.

In addition to the removal of reagent (III) by treatment with an acidic ion exchange resin, intermediate (IV) may be purified by precipitation from diethyl ether, by recrystallization from isopropanol, by ion-exchange chromatography, by dialysis, or by other methods applicable to the purification of PEG-derivatives, well known to those skilled in the art. For each intermediate any of these purification methods may be used. The purified intermediate (IV) can then be subjected to the conditions required for the removal of the protective group Pg and then, after an optional purification, be used for the derivatization of a peptide derived aldehyde or ketone.

The removal of protecting groups is well-known in the art. By way of example, treatment with TFA will remove acid-labile protecting groups such as Boc.

Particular examples of compounds of formula I include

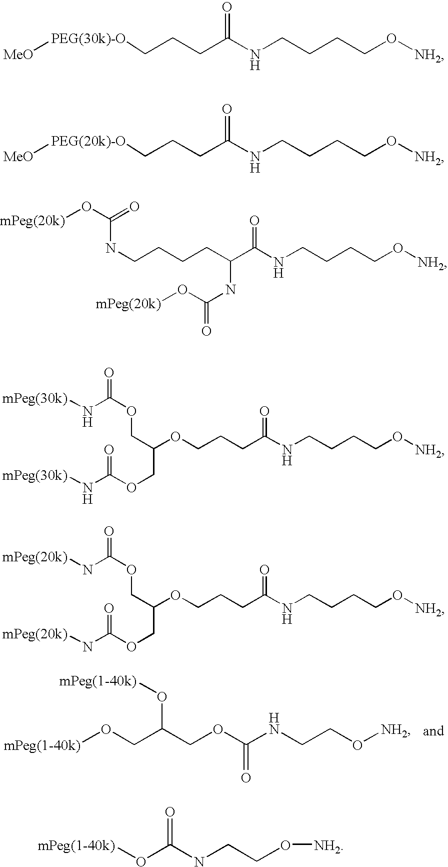

### EXAMPLES

The following abbreviations are used
Boc: tert-butyloxycarbonyl
Fmoc: 9-fluorenylmethyloxycarbonyl
Cbz: benzyloxycarbonyl
Bpoc: 1-(4-biphenylyl)-1-methylethoxycarbonyl

Mpc: 1-(4-methylphenyl)-1-methylethoxycarbonyl

Ddz: 1-(3,5-dimethoxyphenyl)-1-methylethoxycarbonyl
Adpoc: 1-(1-adamantyl)-1-methylethoxycarbonyl
Alloc: allyloxycarbonyl
Troc: 2,2,2-trichloroethyloxycarbonyl
DIPEA: diisopropylethylamine
DMAP: 4-dimethylaminopyridine
TFA: trifluoroacetic acid
An exemplary method of the present invention, starting from readily available starting materials, is depicted in the reaction scheme below.

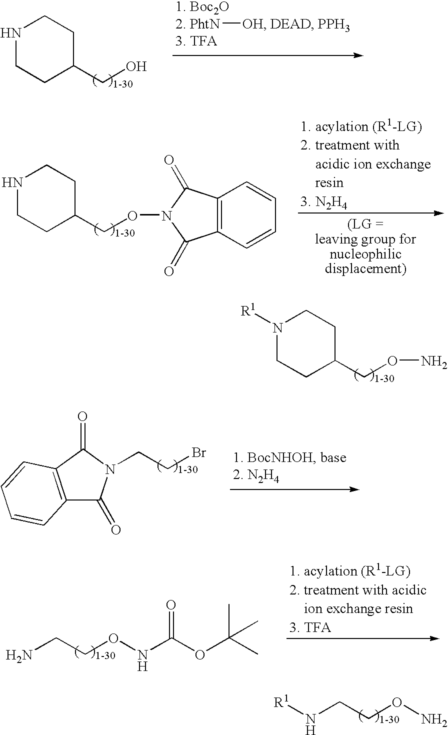

### Example 1

### O-(4-(4-(1,3-bis(mPEG(20K)oxy)-2-propyloxy)butyrylamino)butyl)hydroxylamine (a) N-(tert-Butyloxycarbonylaminoxybutyl)phthalimide

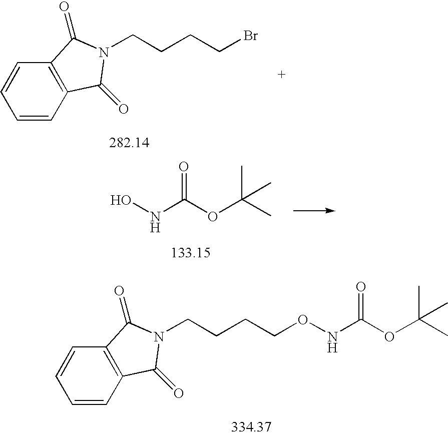

To a stirred mixture of N-(4-bromobutyl)phthalimide (18.9 g, 67.0 mmol), MeCN (14 ml), and N-Boc-hydroxylamine (12.7 g, 95.4 mmol) was added DBU (15.0 ml, 101 mmol) in portions. The resulting mixture was stirred at 50° C. for 24 h. Water (300 ml) and 12 M HCl (10 ml) were added, and the product was extracted three times with AcOEt. The combined extracts were washed with brine, dried (MgSO₄), and concentrated under reduced pressure. The resulting oil (28 g) was purified by chromatography (140 g SiO₂, gradient elution with heptane/AcOEt). 17.9 g (80%) of the title compound was obtained as an oil. ¹H NMR (DMSO-d₆) δ 1.36 (s, 9H), 1.50 (m, 2H), 1.67 (m, 2H), 3.58 (t, J=7 Hz, 2H), 3.68 (t, J=7 Hz, 2H), 7.85 (m, 4H), 9.90 (s, 1H).

### (b) 4-(tert-Butyloxycarbonylaminoxy)butylamine

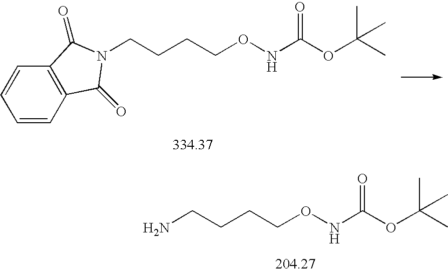

To a solution of N-(tert-butyloxycarbonylaminoxybutyl)phthalimide obtained from (a) (8.35 g, 25.0 mmol) in EtOH (10 ml) was added hydrazine hydrate (20 ml), and the mixture was stirred at 80° C. for 38 h. The mixture was concentrated and the residue coevaporated with EtOH and PhMe. To the residue was added EtOH (50 ml), and the precipitated phthalhydrazide was filtered off and washed with EtOH (50 ml). Concentration of the combined filtrates yielded 5.08 g of an oil. This oil was mixed with a solution of K₂CO₃ (10 g) in water (20 ml), and the product was extracted with CH₂Cl₂. Drying (MgSO₄) and concentration yielded 2.28 g (45%) of the title compound as an oil, which was used without further purification. ¹H NMR (DMSO-d₆) δ 1.38 (m, 2H), 1.39 (s, 9H), 1.51 (m, 2H), 2.51 (t, J=7 Hz, 2H), 3.66 (t, J=7 Hz, 2H).

### (c) N-Boc-O-(4-(4-(1,3-bis(mPEG(20K)oxy)-2-propyloxy)butyrylamino)butyl)hydroxylamine

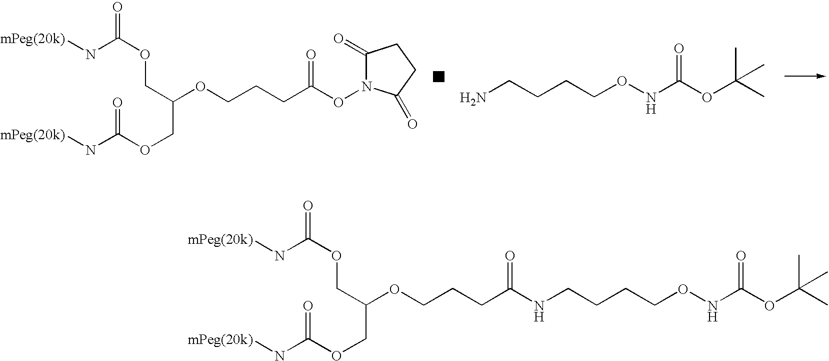

(mPeg-NH—CO—O—CH₂)₂CH—O—(CH₂)₃—CO—OSu (Nektar, 2Z3Y0T01, 2.0 g, 50 μmol) was mixed with a solution of 4-(Boc-aminoxy)butylamine (187 mg, 915 μmol) in DCM (12 ml). After stirring at room temperature for 43 h the mixture was added dropwise to stirred Et₂O (200 ml). Filtration, washing with Et₂O. The product was redissolved in DCM (10 ml), and precipitated once more from Et₂O (200 ml). This precipitation was repeated three times. The product was then dissolved in DCM (100 ml) and treated with Amberlyst 15 (11 g; washed with DCM) for 5 min. After filtration and concentration the product was precipitated from Et₂O as above. Filtration and drying under reduced pressure yielded 1.98 g of the title compound as a solid.

### (d) O-(4-(4-(1,3-bis(mPEG(20K)oxy)-2-propyloxy)butyrylamino)butyl)hydroxylamine

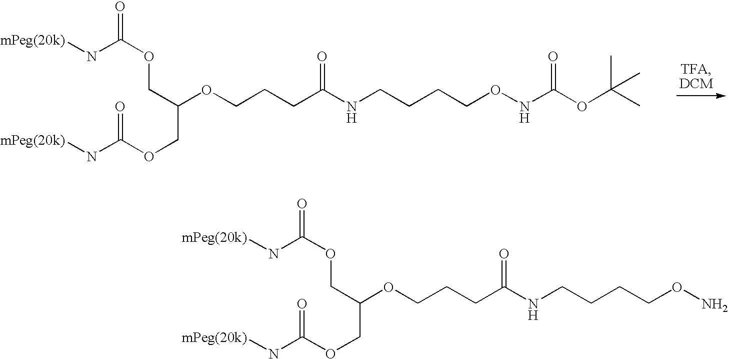

The product from the previous reaction (1.98 g) was dissolved in DCM, and Amberlyst 15 (7.5 g; washed with DCM) was added. After stirring for 5 min the mixture was filtered and the filtrate concentrated. To the residue were added DCM (40 ml) and TFA (40 ml). After standing at room temperature for 0.5 h the mixture was concentrated, the residue coevaporated twice with a mixture of DCM and toluene, and dried under reduced pressure overnight. The residue was dissolved in water (33 ml) and neutralized by addition of 2-methylpyridine (1.5 ml) to pH 5-6. This solution was used directly for the oximation of protein-derived aldehydes.

All references, including publications, patent applications and patents, cited herein are hereby incorporated by reference to the same extent as if each reference was individually and specifically indicated to be incorporated by reference and was set forth in its entirety herein.

All headings and sub-headings are used herein for convenience only and should not be construed as limiting the invention in any way,

Any combination of the above-described elements in all possible variations thereof is encompassed by the invention unless otherwise indicated herein or otherwise clearly contradicted by context.

The terms “a” and “an” and “the” and similar referents as used in the context of describing the invention are to be construed to cover both the singular and the plural, unless otherwise indicated herein or clearly contradicted by context.

Recitation of ranges of values herein are merely intended to serve as a shorthand method of referring individually to each separate value falling within the range, unless otherwise indicated herein, and each separate value is incorporated into the specification as if it were individually recited herein. Unless otherwise stated, all exact values provided herein are representative of corresponding approximate values (e.g., all exact exemplary values provided with respect to a particular factor or measurement can be considered to also provide a corresponding approximate measurement, modified by “about,” where appropriate).

All methods described herein can be performed in any suitable order unless otherwise indicated herein or otherwise clearly contradicted by context.

The use of any and all examples, or exemplary language (e.g., “such as”) provided herein, is intended merely to better illuminate the invention and does not pose a limitation on the scope of the invention unless otherwise indicated. No language in the specification should be construed as indicating any element is essential to the practice of the invention unless as much is explicitly stated.

The citation and incorporation of patent documents herein is done for convenience only and does not reflect any view of the validity, patentability and/or enforceability of such patent documents,

The description herein of any aspect or embodiment of the invention using terms such as “comprising”, “having”, “including” or “containing” with reference to an element or elements is intended to provide support for a similar aspect or embodiment of the invention that “consists of”, “consists essentially of”, or “substantially comprises” that particular element or elements, unless otherwise stated or clearly contradicted by context (e.g., a composition described herein as comprising a particular element should be understood as also describing a composition consisting of that element, unless otherwise stated or clearly contradicted by context).

This invention includes all modifications and equivalents of the subject matter recited in the aspects or claims presented herein to the maximum extent permitted by applicable law.

1. A method for preparing a compound according to formula I,
R¹—R²—O—NH₂ (I)
wherein R¹ is a monovalent acyl radical of formula 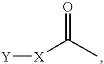
wherein X represents a bond, arylene, (CH₂)₁₋₁₀, NH, O, S, or combinations thereof, and
Y represents a branched or unbranched PEG-derived radical having a mean molecular weight between 100 Da and 80 kDa; and
R² is a diradical of formula 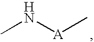
wherein A represents arylene, alkylene, cycloalkylene, heteroarylene, partially or completely saturated heteroarylene, or combinations thereof, each of which optionally substituted with a lower alkyl, the method comprising the steps of
(i) treating a compound of formula II
R¹-LG (II),
wherein LG represents a leaving group for nucleophilic displacement, with an excess of a compound of formula III
H—R²—O—NH-Pg (III)
wherein Pg represent a protective group in a suitable solvent or solvent mixture;
(ii) isolating any compound of formula (IV)
R¹—R²—O—NHPg (IV); and
(iii) removing the protective group to obtain a compound of formula I.

2. The method of claim 1, wherein R¹ represents 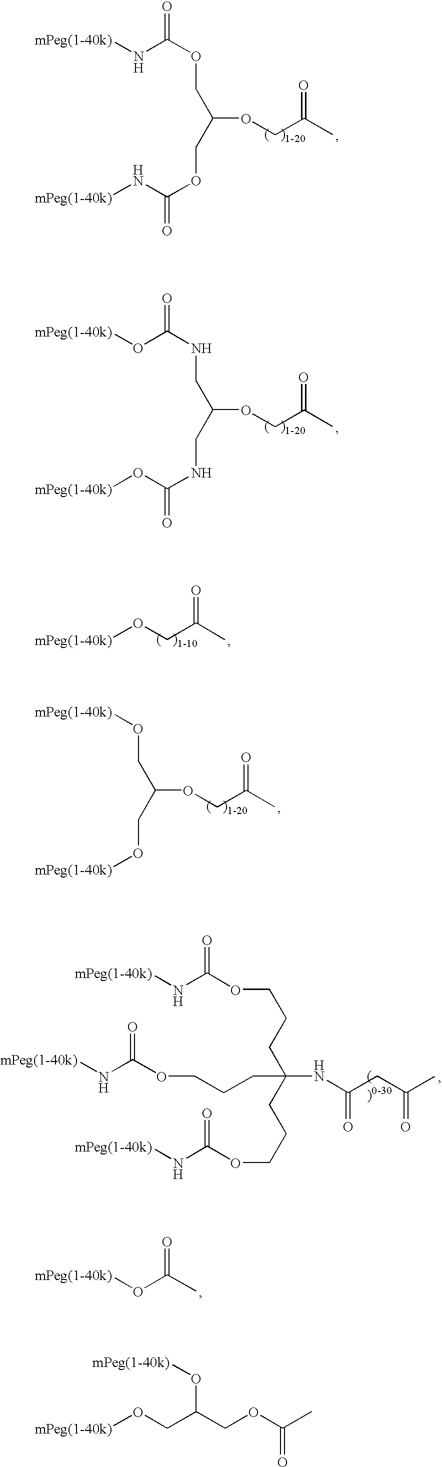 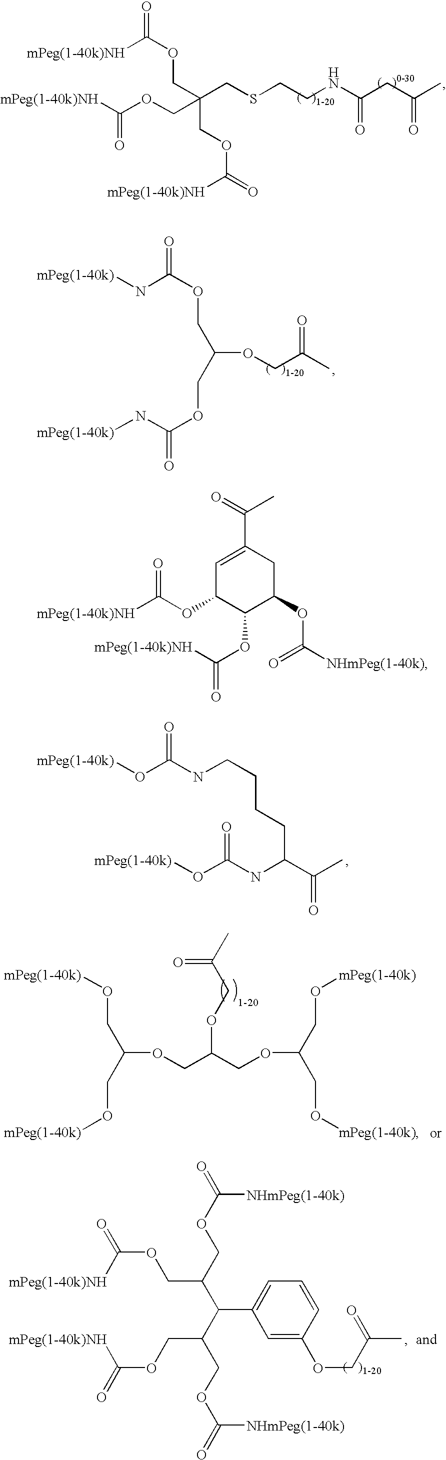
R² represents 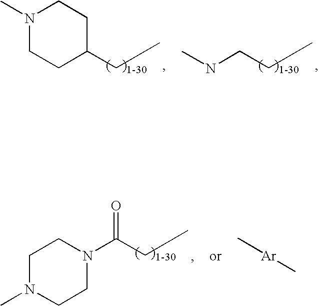
wherein Ar represents arylene or heteroarylene, each of which optionally substituted with one or more substituents selected from carboxy, hydroxyl, nitro, or cyano.

3. The method of claim 1, wherein R¹ is

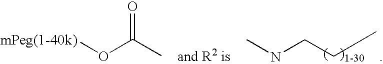

4. The method of claim 1, wherein R¹ is

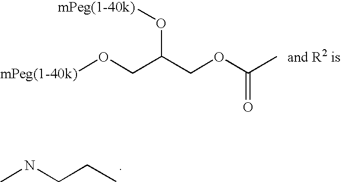

5. The method of claim 1, wherein the isolating step (ii) comprises a precipitation step wherein a large amount of a first precipitating solvent is added to the reaction mixture in (i), in which solvent the compound of formula IV is essentially insoluble and in which the reaction solvent and the compound of general formula III are soluble.

6. The method of claim 5, further comprising a step of filtration to isolate the precipitate comprising the compound of formula IV.

7. The method of claim 6, further comprising adding to the isolated precipitate a solvent in which the compound of formula IV is soluble.

8. The method of claim 7, further comprising adding a suspension of an acidic ion exchange resin in a suitable solvent, stirring the resulting mixture for a predetermined amount of time, followed by filtration and rinsing of the ion exchange resin, and collection and optionally concentration of the combined filtrates.

9. The method of claim 8, further comprising optionally adding a second precipitating solvent to precipitate the compound of formula IV.

10. The method of claim 1, wherein Pg in the compound of formula (III) is Boc.

11. The method of claim 1, wherein the solvent in step (i) is dichloromethane.

12. The method of claim 1, wherein the excess of the compound of formula (III) is 1.5- to 300-fold.

13. The method of claim 5, wherein the first precipitating solvent is diethylether.

14. The method of claim 8, wherein the predetermined amount of time is from 1 min to 10 hours.

15. A method for the preparation of compounds accordingly to formula I,
R¹—R²—O—NH₂ (I)
wherein R¹ represents 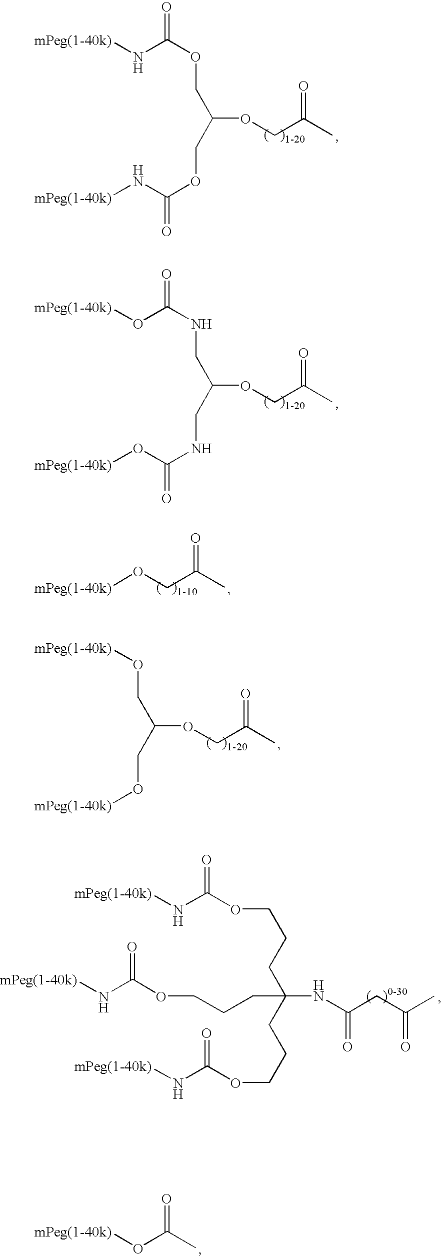 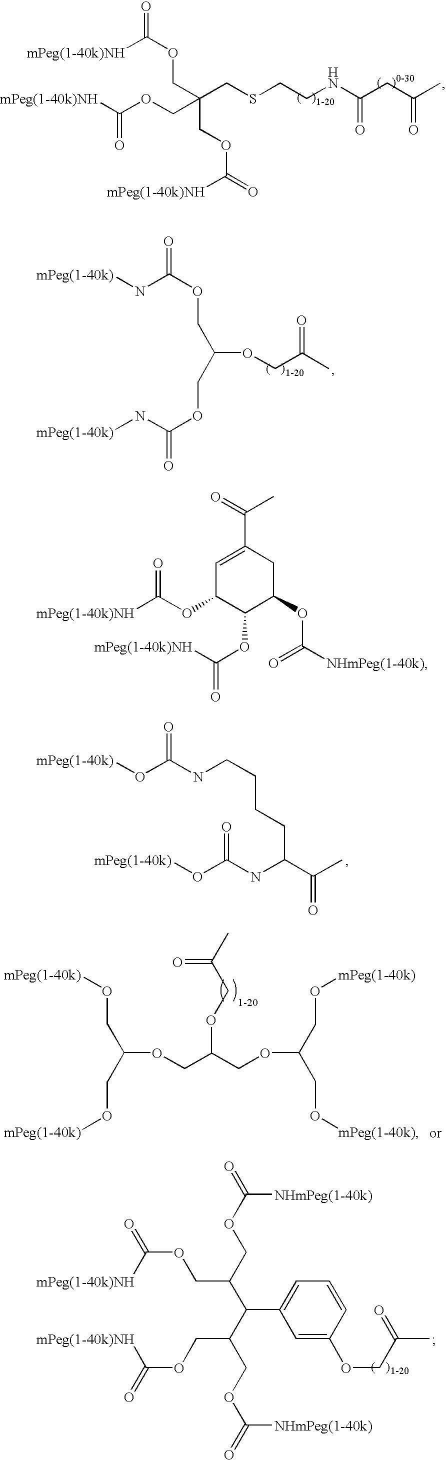
R² represents 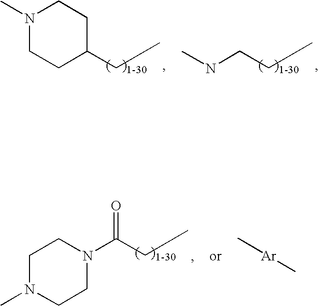
wherein Ar represents arylene or heteroarylene, both of which may optionally be substituted with one or more substituents selected from carboxy, hydroxyl, nitro, or cyano, the method comprising the steps of
(a) treating a compound of formula II
R¹-LG (II),
wherein LG represents a leaving group for nucleophilic displacement, with an excess of a compound of the formula (III)
H—R²—O—NH-Pg (III),
wherein Pg represent a protective group in a suitable solvent or solvent mixture, followed by
(b) precipitation of the product obtained in (a) by addition a large amount of a suitable solvent, in which the compound of formula (IV) is essentially insoluble, and the reaction solvent and the compound of general formula (III) are soluble, wherein the compound of formula IV is the compound of formula I with a protection group, i.e.
R¹—R²—O—NHPg (IV)
followed by,
(c) isolation of the compound of formula (IV) by filtration, followed by
(d) addition of a suitable solvent in which the compound of formula (IV) is soluble to the product isolated in step (c), followed by
(e) optional repetition of the precipitation, filtration and solubilisation steps of (b) and (c), followed by
(f) addition of a suspension of an acidic ion exchange resin in a suitable solvent, stirring the resulting mixture, followed by filtration and rinsing of the ion exchange resin, and collection and optionally concentration of the combined filtrates, followed by
(g) optional addition of a suitable solvent to precipitate the compound of formula (IV), followed by filtration and solubilisation as described in steps (b) and (c), followed by
(h) removal of the protective group with a suitable reagent to obtain a compound of formula I, and optional removal of the solvent and un-reacted reagent.

16. The method of claim 15, wherein the protective group in the compound of formula (III) is Boc.

17. The method of claim 15, wherein the solvent in step (a) is dichloromethane.

18. The method of claim 15, wherein the excess of the compound of formula (III) is 1.5 to 300 fold.

19. The method of claim 15, wherein the solvent in step (b) is diethylether.

20. The method of claim 15, wherein the resulting mixture is stirred for 1 min to 10 hours.

21. The method of claim 15, which further comprises an ion exchange chromatography step.

22. The method of claim 15, which further comprises a step, wherein the compounds are recrystallised from isopropanol.

23. The method of claim 15, which further comprises a dialysis step.
